(19) United States
(12) Patent Application Publication
(10) Pub. No.: US 2014/0286517 A1
(43) Pub. Date: Sep. 25, 2014

(54) NETWORK OF SPEAKER LIGHTS AND WEARABLE DEVICES USING INTELLIGENT CONNECTION MANAGERS

(71) Applicants: Michael Edward Smith Luna, San Jose, CA (US); Patrick Alan Narron, Boulder Creek, CA (US); Derek Boyd Barrentine, Gilroy, CA (US); Scott Fullam, Palo Alto, CA (US)

(72) Inventors: Michael Edward Smith Luna, San Jose, CA (US); Patrick Alan Narron, Boulder Creek, CA (US); Derek Boyd Barrentine, Gilroy, CA (US); Scott Fullam, Palo Alto, CA (US)

(73) Assignee: AliphCom, San Francisco, CA (US)

(21) Appl. No.: 14/209,329

(22) Filed: Mar. 13, 2014

Related U.S. Application Data
(60) Provisional application No. 61/786,179, filed on Mar. 14, 2013.
(60) Provisional application No. 61/786,473, filed on Mar. 15, 2013.
(60) Provisional application No. 61/825,509, filed on May 20, 2013.

(51) Int. Cl. H04R 1/02; H05B 37/02; G05B 15/02

(52) U.S. Cl. CPC H04R 1/028; G05B 15/02; H05B 37/0227
USPC 381/332

(57) ABSTRACT

Techniques for managing a network of speaker lights and wearable devices using intelligent connection managers are described. Disclosed are techniques for receiving data representing a distance between a wearable device and a speaker light, the speaker light associated with an identifier, and generating an audio control signal and a light control signal as a function of the distance. The audio control signal may include data representing an audio parameter and data representing the identifier, and the light control signal may include data representing a light parameter and data representing the identifier. Presentation of an audio signal using the audio parameter and a light using the light parameter may be caused at the speaker light. The audio signal and the light may be substantially directed towards the wearable device or a user.

### CROSS REFERENCE TO RELATED APPLICATIONS

This application claims the benefit of U.S. Provisional Patent Application No. 61/786,179, filed Mar. 14, 2013, U.S. Provisional Patent Application No. 61/786,473, filed Mar. 15, 2013, and U.S. Provisional Patent Application No. 61/825,509, filed May 20, 2013; this application is also related to co-pending U.S. patent application Ser. No. 13/831,447, filed Mar. 14, 2013, co-pending U.S. patent application Ser. No. 13/831,698, filed Mar. 15, 2013, and co-pending U.S. patent application Ser. No. 13/831,689, filed Mar. 15, 2013; this application is also related to co-pending U.S. patent application Ser. No. 13/954,331, filed Jul. 30, 2013; this application is also related to co-pending U.S. patent application Ser. No. 13/954,367, filed Jul. 30, 2013; all of which are incorporated by reference herein in their entirety for all purposes.

### FIELD

Various embodiments relate generally to electrical and electronic hardware, computer software, human-computing interfaces, wired and wireless network communications, telecommunications, data processing, and computing devices. More specifically, disclosed are techniques for managing a network of speaker lights and wearable devices using intelligent connection managers.

### BACKGROUND

There is an increasing demand for automation of home and office devices. Conventional devices generally may provide independent automated devices. For example, an automated light may be controlled independently from an automated thermostat. Further conventional devices included in an automated network or environment generally do not include a device that may present audio and light and may be powered using a light socket. Further, it may be conventionally difficult to create an automated environment due to a limitation on the number and position of sensors that may be installed in the environment.

Thus, what is needed is a solution for managing a network of speaker lights and wearable devices without the limitations of conventional techniques.

### BRIEF DESCRIPTION OF THE DRAWINGS

Various embodiments or examples (“examples”) are disclosed in the following detailed description and the accompanying drawings:

FIG. 1 illustrates a network of speaker lights, wearable devices, and other devices, using an intelligent connection manager, according to some examples;

FIG. 2 illustrates an application architecture for an intelligent connection manager, according to some examples;

FIG. 3A illustrates an application architecture for an audio control generator, according to some examples;

FIG. 3B illustrates an application architecture for a light control generator, according to some examples;

FIG. 4 illustrates a speaker light to be used with an intelligent connection manager, according to some examples;

FIG. 5 illustrates an application architecture of a speaker light, according to some examples;

FIG. 6 illustrates a network of speaker lights, wearable devices, and other devices, using an intelligent connection manager, according to some examples;

FIG. 7 illustrates a process for an intelligent connection manager, according to some examples; and

FIG. 8 illustrates a computer system suitable for use with an intelligent connection manager, according to some examples.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

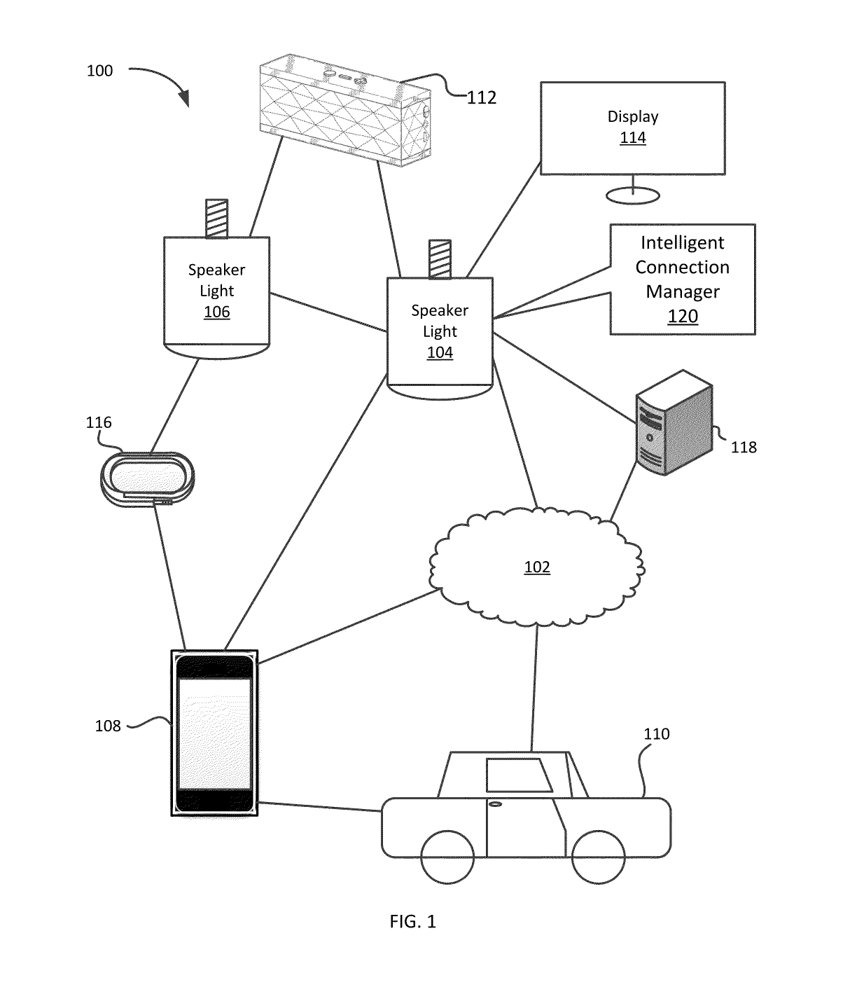

FIG. 1 illustrates a network of speaker lights, wearable devices, and other devices, using an intelligent connection manager, according to some examples. As shown, system 100 includes network 102, speaker lights 104-106, mobile device or smartphone 108, car 110, media device or speaker box 112, display 114, wearable device (e.g., data-capable strapband or band) 116, server 118, and intelligent connection manager 120. Intelligent connection manager 120 may be configured to manage a network of speaker lights, wearable devices, and other devices. Intelligent connection manager 120 may provide one or more control signals to present audio and/or light at one or more speaker lights 104-106. Audio parameters, such as audio content or channel, volume or amplitude, sound direction, and the like, and light parameters, such as luminosity or brightness, color, light direction, and the like, may be determined as a function of characteristics of the network, such as a distance between a speaker light and a wearable device, a location of a speaker light with respect to a wearable device, a grouping of speaker lights and other devices, and the like.

In some examples, intelligent connection manager 120 may generate an audio control signal and a light control signal as a function of a distance between wearable device 116 and speaker light 104. The audio control signal may include data representing an audio parameter, and the light control signal may include data representing a light parameter. Intelligent connection manager 120 may cause presentation of an audio signal using the audio parameter and a light using the light parameter at speaker light 104. The audio parameter may specify or describe an audio content or channel, volume or amplitude, sound direction, and the like. The light parameter may specify or describe luminosity or brightness, color, light direction, and the like. In some examples, intelligent connection manager may turn off or present no audio signal and/or light at speaker light 104 if the distance between wearable device 116 and speaker light 104 exceeds a threshold, and may turn on an audio signal and/or light at speaker light 106 if the distance between wearable device 116 and speaker light 106 is within a threshold. For example, a user of wearable device 116 walks from a room in which speaker light 104 is located to another room in which speaker light 106 is located. Intelligent connection manager 120 may automatically turn off speaker light 104 and turn on speaker light 106. Intelligent connection manager 120 may also function with other devices, such as smartphone 108, car 110, media device 112, display 114, and the like. For example, a user may listen to a song in car 110. The user may leave car 110, and intelligent connection manager 120 may detect that the distance between the user and car 110 exceeds a threshold. Intelligent connection manager 120 may generate a control signal to present the song at smartphone 108. The user may enter a house, where speaker light 104 is located, and intelligent connection manager 120 may detect that the distance between the user and speaker light 104 is within a threshold. Intelligent connection manager 120 may generate a control signal to present the song at speaker light 104.

In some examples, intelligent connection manager may determine a location of speaker light 104 with respect to wearable device 116, which may be determined based on the distance between wearable device 116 and speaker light 104. In some examples, the audio signal and/or light may be substantially directed at wearable device 116 or a user of wearable device 116. For example, an audio signal may be substantially directed at wearable device 116 such that a user of wearable device 116 may hear or receive the audio signal while other people nearby (e.g., in the same room or zone) may not hear the audio signal. For example, an audio signal and/or light may be substantially directed at wearable device 116 such that an amplitude or strength of the audio signal and/or light received at wearable device 116 is stronger than the strength of the audio signal and/or light received at other locations that are nearby or substantially a same distance away from speaker light 104. In some examples, the audio signal may present an audio channel of a surround sound media content or soundtrack, or an audio channel of a 3D audio (three dimensional audio) soundtrack. A surround sound or 3D soundtrack may have two or more audio channels, each audio channel configured to be presented from a certain location with respect to the user. For example, speaker light 104 may be located towards the rear of wearable device 116, and the audio signal may present a rear audio channel at speaker light 104. In some examples, the audio parameter and/or light parameter may be generated based on a number of wearable devices detected within a vicinity, a number of speaker lights detected within a vicinity, and the like. In some examples, the audio parameter and/or light parameter may be generated based on an activity or physiological state of a user or an environmental state, which may be detected based on sensor data from one or more sensors, which may be coupled to wearable device 116, speaker lights 104-106, or other devices. For example, three people may be detected in a room, and soft music that may suitable for a social setting may be presented. As another example, one person going to sleep may be detected in a room, and white noise that may be suitable for sleep onset may be presented. For example, a dimmer light that may be more suitable for a social setting may be presented when there are three wearable devices detected within a vicinity. As another example, a whiter light that may be more suitable for productivity may be presented when there is one wearable device detected within a vicinity. In some examples, the audio parameter and/or light parameter may be configured to represent an alarm, which may be triggered based on one or more physiological or environmental states, or other data, which may be associated with the same or a different room or zone. For example, an alarm including a siren sound and a blinking light may be presented in a room in which wearable device 116 is located in response to a high level of carbon dioxide detected in another room (e.g., a nursery).

In some examples, intelligent connection manager 120 may be integrated, implemented, executed, or installed on speaker light 104, server 118, or other devices, or may be distributed amongst speaker light 104, server 118, and/or other devices. In some examples, intelligent connection manager 120 may generate an audio control signal and/or light control signal that may include data representing an identifier of a device to be used to present an audio signal and/or light. The identifier may be a name, address, identity number, or the like, and may be unique to each device. For example, intelligent connection manager 120 may be implemented at server 118. Each of the devices 104-116 may be in data communication with server 118. Intelligent connection manager 180 may generate a control signal including data representing an identifier of a device, such as speaker light 104, in order to cause presentation of an audio signal and/or light at the device. The data representing the identifier may be used to transmit the control signal to the device, to verify that the control signal was intended for the device, or for other purposes.

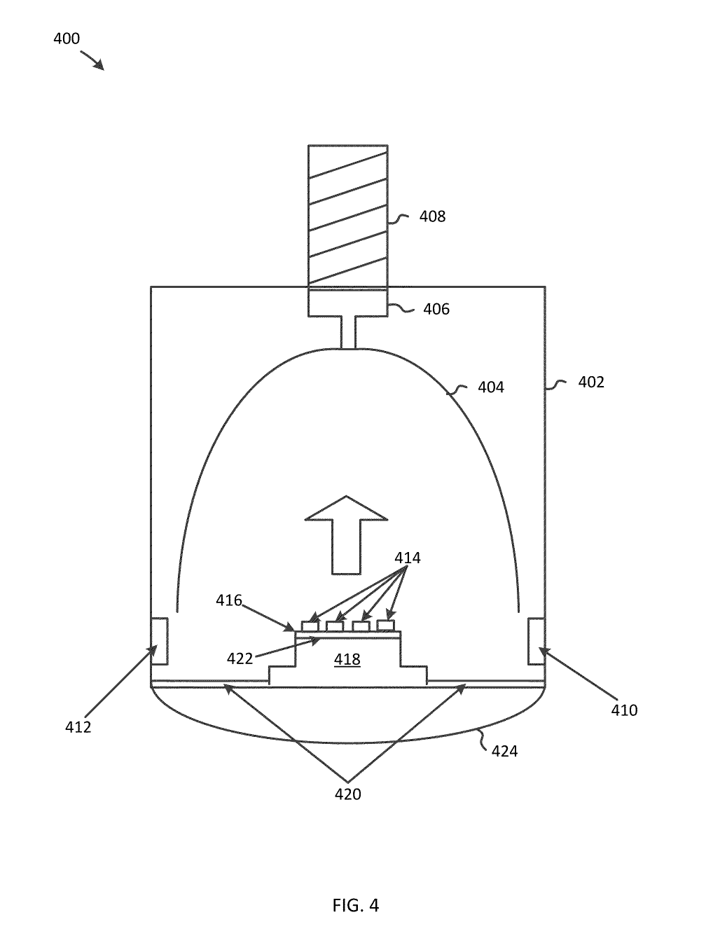

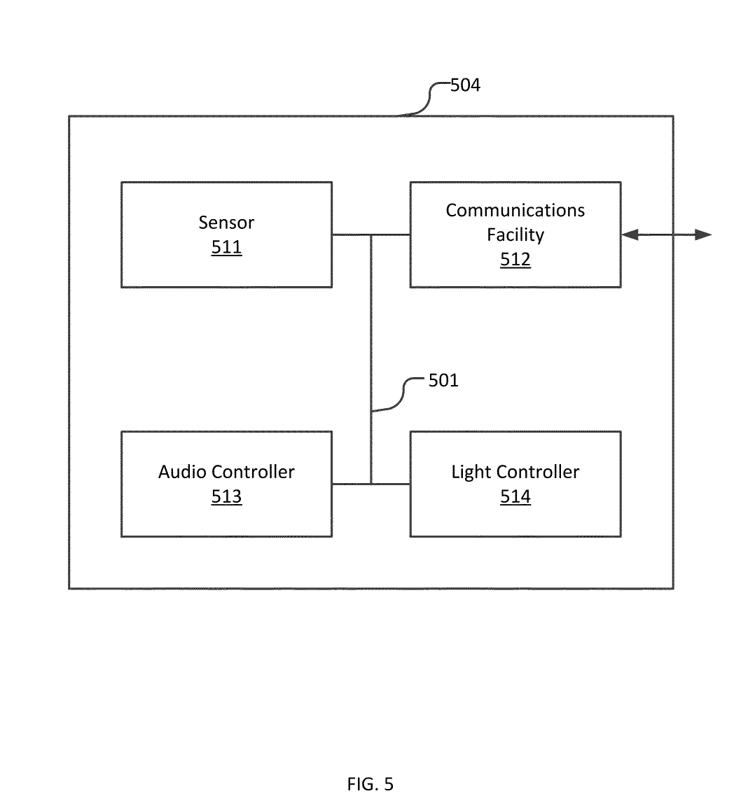

Speaker lights 104-106, also referred to as combination speaker and light sources, may be configured to provide both an audio signal and light and may be powered using a light socket (e.g., see FIGS. 4-5). Speaker lights 104-106 may be coupled to various types of sensors, which may be configured to collect sensor data associated with a user or an environment, as described herein. In some examples, speaker lights 104-106 may be configured to be installed or located on a ceiling of a room or structure. In such cases, sensors located at speaker lights 104-106 may have a birds' eye view of the vicinity. Sensors may capture various data with minimal or no interference or obstruction in the horizontal plane. In such cases, speaker lights 104-106 may present audio signals and light from the top of a user. In some examples, more than one speaker light may be installed in a vicinity. For example, multiple recessed ceiling speaker lights 104-106 may be installed. Speaker lights 104-106 may present audio and light from a plurality of locations within the vicinity. A plurality of sensors may also be installed with the plurality of speaker lights 104-106, thus increasing the amount of sensor data to be captured and used by intelligent connection manager 120. In some examples, speaker lights 104-106 may be used in other positions or configurations. Speaker lights 104-106 may include other functional capabilities (e.g., communication functions, device control functions, sensor functions, or the like), as described herein.

Mobile device 108 may include both communication and computing capabilities, as well as media playing capabilities, and be configured for data communication using various types of communications infrastructure, including a wireless network connection (e.g., a wireless network interface card, wireless local area network (“LAN”) card, or the like). For example, mobile device 108 may be configured to receive and carry telephone or video conference calls. In another example, mobile device 108 also may be configured with an operating system configured to run various applications (e.g., mobile applications, web applications, and the like), including playing media content (e.g., radio, playlist, other music, movie, online video, other video, and the like) using various types of media players.

Wearable device 116 may be a data-capable band, which may be configured for data communication using various types of communications infrastructure, including a wireless network connection (e.g., a wireless network interface card, wireless local area network (“LAN”) card, or the like). In some examples, wearable device 116 may include various types of sensors, which may be configured to collect sensor data associated with a user or an environment. Wearable device 116 may be may be worn on or around an arm, leg, ear, or other bodily appendage or feature, or may be portable in a user's hand, pocket, bag or other carrying case. As an example, a wearable device may be a data-capable band, mobile device or cellular telephone, headset, watch, data-capable eyewear, tablet, laptop, or other computing device.

Media device or speaker box 112 may be implemented as any device configured to output audio, and may include other functional capabilities (e.g., communication functions, device control functions, sensor functions, or the like). In some examples, media device 112 may be configured with a microphone to receive or capture audio input. Display 114 may be configured to present visual output as well as audio output, and may include other functional capabilities as well.

Each of the devices 104-118 may be coupled to one or more sensors (e.g., accelerometer, altimeter/barometer, light/infrared (“IR”) sensor, pulse/heart rate (“HR”) monitor, audio sensor (e.g., microphone, transducer, or others), pedometer, velocimeter, global positioning system (GPS) receiver, location-based service sensor (e.g., sensor for determining location within a cellular or micro-cellular network, which may or may not use GPS or other satellite constellations for fixing a position), motion detection sensor, environmental sensor, chemical sensor, electrical sensor, mechanical sensor, and the like). A sensor may be local to the device (e.g., integrated, installed, manufactured, or fabricated on the device) or may be remote from and in data communication, direct or indirect, with the device. Each of the devices 104-118 may be in direct communication with each other, or in indirect communication with each other (e.g., via network 102, server 118, or another device). Various types of wired or wireless communications may be used. Still, other implementations or configurations associated with the network of speaker lights, wearable devices, and other devices, and associated with intelligent connection manager 120 may be used.

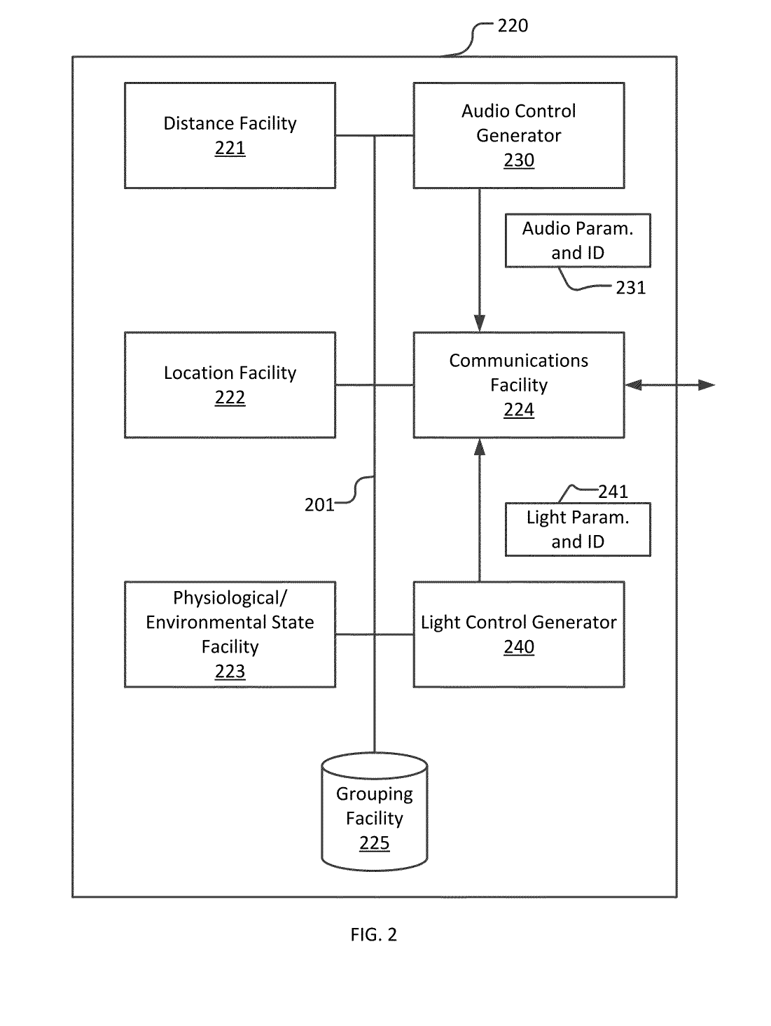

FIG. 2 illustrates an application architecture for an intelligent connection manager, according to some examples. As shown, intelligent connection manager 220 may include a bus 201, a distance facility 221, a location facility 222, a physiological/environmental state facility 223, a communications facility 224, a grouping facility 2252, an audio control generator 230, and a light control generator 240. As used herein, “facility” refers to any, some, or all of the features and structures that are used to implement a given set of functions, according to some embodiments. Elements 311-316 may be integrated with intelligent connection manager 220 (as shown) or may be distributed or remote from intelligent connection manager 220. In some examples, intelligent connection manager 220 may use communications facility 224 to communicate with a speaker light or other device to be used for presenting audio and/or light. Intelligent connection manager 220 may transmit a control signal (e.g., an audio control signal and/or a light control signal) to another device using communications facility 224. In other examples, intelligent connection manager 220 may be integrated with a device to be used for presenting audio and/or light. Intelligent connection manager 220 may transmit a control signal through bus 201 or another means of communication.

Distance facility 221 may be configured to determine a distance between two devices or objects (including users). Distance may be determined using various types of sensor data. For example, a sensor located at a speaker light may detect the strength or intensity of a wireless signal (e.g., Wi-Fi, Bluetooth, etc.) being transmitted from a device, such as a wearable device, which may be used to determine distance. For example, the higher the intensity of the signal received, the closer the wearable device is to the speaker light. As another example, a speaker light may use an ultrasonic sensor to detect the distance of other devices and objects. An ultrasonic sensor may generate high frequency sound waves and evaluate the echo which is received back at the sensor. Other waves, such as radar, sonar, and the like, may also be used. Examples of implementations may be found in co-pending U.S. patent application Ser. No. 13/954,331, filed Jul. 30, 2013, and co-pending U.S. patent application Ser. No. 13/954,367, filed Jul. 30, 2013, all of which are incorporated by reference herein in their entirety for all purposes. Distance facility 221 may store data representing the distances between various objects. For example, distance facility 221 may have a memory storing the distance between a first speaker light and a first wearable device, the distance between the first speaker light and a second wearable device, the distance between a second speaker light and the first wearable device, and the like. Data representing a distance may be received at intelligent connection manager 220 from distance facility 221 or communications facility 224. In some examples, distance facility 221 may be integrated with intelligent connection manager 220 (as shown). In other examples, distance facility 221 or portions thereof may be remote and may communicate with intelligent connection manager 220 using communications facility 224. Still, other implementations may be used.

Location facility 222 may be configured to determine a location (e.g., x, y, z coordinates) of a device with respect to another device or a user. In some examples, location facility 222 may use a method of trilateration or triangulation. Data representing distances (received from distance facility 221 or communications facility 224) may be used. For example, a location of a wearable device may be determined using the distances between the wearable device and three or four other devices. When the distances between a reference object and three other objects are known, the possible locations of the reference object may be narrowed down to two. If it is known the altitude of the reference object, then it is possible to determine the location of the reference object. For example, the altitude of a wearable device is associated with the altitude of the floor on which a user is standing. The altitude of the wearable device may also be associated with the height of the user and where the user is wearing or carrying the wearable device. When the distances between a reference object and four other objects are known, then it is possible to determine the location of the reference object. In some examples, location facility 222 may use a sensor located at a first device that is configured to determine an angle between the first device and a second device. For example, an ultrasonic sensor may be used to determine an angle with another device. Using the angle and a distance, location facility 222 may determine a location of the device. In some examples, location facility 222 may use location data, such as longitudinal and latitudinal coordinates, which may be received from a GPS receiver, to determine a location of a device with respect to another device. Still, other implementations may be used.

Distance facility 221 and/or location facility 222 may determine whether a device or user is within a zone of another device. A zone may be an area in which an intelligent connection manager 220 may initiate or manage a connection or interaction between devices and/or users. For example, a speaker light and a user may be in the same zone, and intelligent connection manager 220 may manage a connection between them (e.g., turn on the speaker light, etc.). A zone may be a room, such as a living room, kitchen, bedroom, and the like. A zone may be a portion of a room, a group of rooms, and the like. Distance facility 221 may determine that two devices are in the same zone using a distance between the two devices. For example, a speaker light may be installed at a location that is a certain distance away from a boundary of a zone (e.g., a wall, door, entry way, etc., of a room). A wearable device coming within that distance may be determined to be within the same zone. Location facility 222 may determine that two devices are in the same zone using the respective locations of the devices. For example, a speaker light may be installed at a certain location with respect to a boundary of a zone, and the location of the boundary with respect to the speaker light may be known. A wearable device passing the boundary may be determined to be within the same zone. The distance from a boundary or the location of a boundary may be manually entered by a user, or may be determined by intelligent connection manager 220, for example, by using ultrasonic sensors.

Physiological/environmental state facility 223 may be used to process and evaluate sensor data. Sensor data may be received from one or more local sensors coupled to intelligent connection manager 220 and/or one or more remote sensors using communications facility 224. Physiological/environmental state facility 223 may determine a physiological and/or environmental state using sensor data. Physiological/environmental state facility 223 may compare sensor data to one or more templates to determine a match. For example, one template may be a set of sensor data indicating that a user is sleeping. This may include a low level of motion, a low level of sound, a low level of lighting, a time of day, and the like. Another template may be a set of sensor data indicating that a user is exercising. This may include a high level of motion, a high heart rate, and the like. Physiological/environmental state facility 223 may be used to determine a mood of a user, an activity of a user, a health condition of a user, an environmental condition, and other states or conditions associated with a user or environment.

Communications facility 224 may include a wireless radio, control circuit or logic, antenna, transceiver, receiver, transmitter, resistors, diodes, transistors, or other elements that are used to transmit and receive data, including broadcast data packets, from other devices. In some examples, communications facility 224 may be implemented to provide a “wired” data communication capability such as an analog or digital attachment, plug, jack, or the like to allow for data to be transferred. In other examples, communications facility 224 may be implemented to provide a wireless data communication capability to transmit digitally encoded data across one or more frequencies using various types of data communication protocols, such as Bluetooth, Wi-Fi, 3G, 4G, without limitation.

Grouping facility 225 may be configured to store data representing a grouping of speaker lights and/or other devices. A grouping may be a set of devices that are configured to function cooperatively or in a coordinated fashion. A grouping may be a set of devices that are configured to turn on and off together, to work together to produce surround sound or directed sound, and the like. For example, a grouping of speaker lights may be configured to be turned on to provide light at substantially the same time. A grouping of speaker lights may be configured to provide surround sound, such that one of the set of speaker lights may present a rear audio channel, another may present a right audio channel, and another may present a left audio channel. A function of one grouping may be independent of a function of another grouping. For example, a grouping of speaker lights may begin to present an audio signal, and another grouping of speaker lights may not present an audio signal or may present a different audio signal. Groupings may be based on a variety of factors, such as physical location of the devices, whether the devices are within a threshold distance of each other, whether the devices are within the same zone or room, whether the devices belong to or associated with the same user, and the like. Groupings may be manually entered by the user from a user interface coupled to intelligent connection manager 220, or may be automatically determined by groupings facility 225 using factors such as those mentioned above. Groupings facility 225 may be implemented using various types of data storage technologies and standards, including, without limitation, read-only memory (“ROM”), random access memory (“RAM”), dynamic random access memory (“DRAM”), static random access memory (“SRAM”), static/dynamic random access memory (“SDRAM”), magnetic random access memory (“MRAM”), solid state, two and three-dimensional memories, Flash®, and others. Groupings facility 225 may also be implemented on a memory having one or more partitions that are configured for multiple types of data storage technologies to allow for non-modifiable (i.e., by a user) software to be installed (e.g., firmware installed on ROM) while also providing for storage of captured data and applications using, for example, RAM. Groupings facility 225 may be implemented on a memory such as a server that may be accessible to a plurality of users, such that one or more users may share, access, create, modify, or use groupings stored therein.

Audio control generator 230 and light control generator 240 may be configured to generate a control signal, such as an audio control signal 231 and a light control signal 241, respectively. Audio control generator 230 and light control generator 240 may be implemented as separate facilities or modules (as shown) or may be integrated as one facility or module. Audio control signal 231 may include an audio parameter and an identifier of a device at which the audio signal is to be presented. Light control signal 241 may include a light parameter and an identifier of a device at which the light is to be presented. In some examples, audio control signal 231 and light control signal 241 may be transmitted to communications facility 224 via bus 201 (as shown), and communications facility 224 may cause transmission of the control signals. The device identifier may be used to transmit the control signals to the appropriate device, to confirm proper application of the control signals, and the like. For example, intelligent connection manager 220 may be implemented on a server, and control signals may be transmitted from the server to various devices. As another example, intelligent connection manager 220 may be implemented on a device at which audio and/or light may be presented, and the device may be in communication with other devices that may be controlled or managed by intelligent connection manager 220, and control signals may be transmitted amongst the devices. In other examples, audio control signal 231 and light control signal 241 may be transmitted directly to a speaker light or other device using bus 201. For example, intelligent connection manager 220 may be integrated with or physically coupled to the device at which the audio and/or light is to be presented, and the control signals may directly control the device. In such cases, the controls may not include a device identifier.

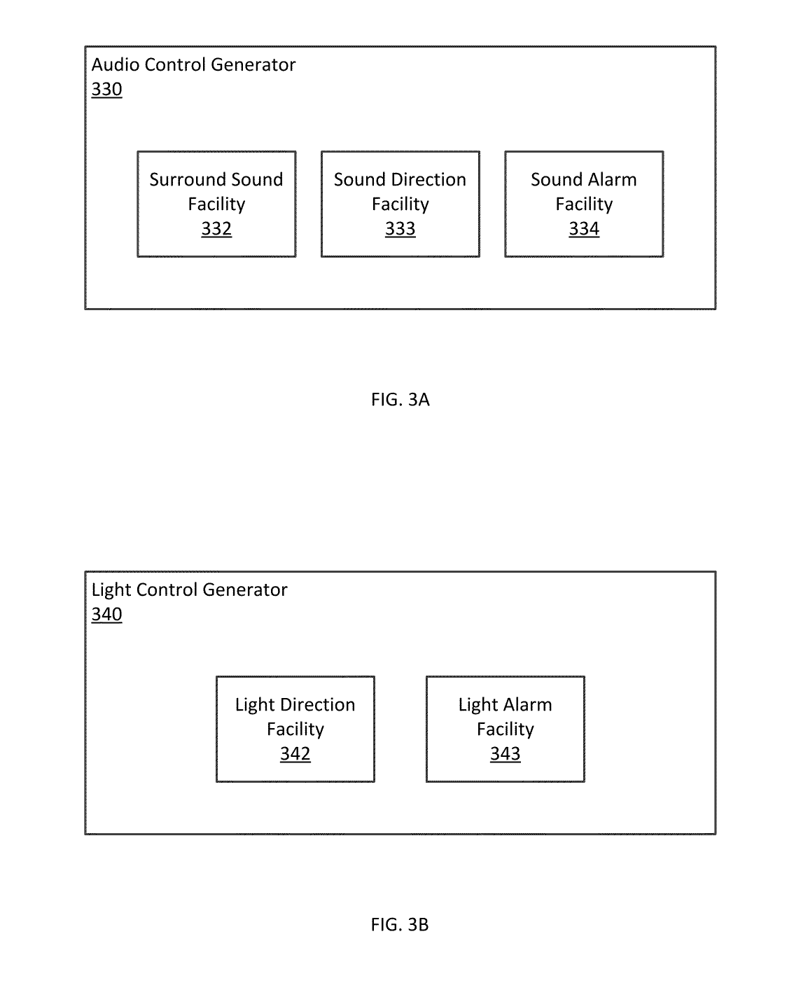

Audio control generator 230 and light control generator 240 may generate control signals as a function of a distance between two devices, and/or as a function of a respective location of a device. Data representing a distance and/or location may be received by intelligent connection manager 220 from distance facility 221, location facility 222, and/or communications facility 224. For example, audio control generator 230 and light control generator 240 may turn on a speaker light to provide audio and light when the distance between two devices is within a threshold. For example, audio and light may be provided at a speaker light when a wearable device comes within a close distance of the speaker light. For example, audio control generator 230 and light control generator 240 may turn on a speaker light to provide audio and light when one device comes into the same zone or room as another device, which may be determined based on distance. When a wearable device moves from a first location to a second location, audio control generator 230 and light control generator 240 may turn off a speaker light located within a proximity of the first location and turn on a speaker light located within a proximity of the second location. For example, audio control generator 230 and light control generator 240 may modify or adjust an audio parameter and a light parameter based on the number of wearable devices or users within a proximity. For example, when a second person enters into a room or zone, a dimmed light and a soft music, which may be suitable for a social setting, may be presented. Audio control generator 230 and light control generator 240 may generate control signals in coordination with each other. For example, audio control generator 230 may generate a control signal to direct an audio signal at a certain location, and light control generator 240 may generate a control signal to direct light at substantially the same location. As another example, a frequency of an audio signal presented at a speaker light may correlate with a brightness of a light presented at the speaker light. Other relationships between the audio control signal and the light control signal may be used. Further operations and functionalities of audio control generator 230 and light control generator 240 are described herein (e.g., see FIGS. 3A and 3B).

FIG. 3A illustrates an application architecture for an audio control generator, according to some examples. As shown, audio control generator 330 includes surround sound facility 332, sound direction facility 333, and sound alarm facility 334. In some examples, surround sound facility 332 may generate audio control signals for a plurality of devices to present a plurality of audio channels configured to present a surround sound soundtrack or media experience. A surround sound soundtrack may use any number of a plurality of audio channels. An audio channel may be configured to be presented from an audio channel location, which may be a certain location with respect to the user for the user to enjoy the surround sound experience. An audio channel may be placed on the same horizontal plane as the user, or may be located above or below the horizontal plane of the user (e.g., height channels). For example, surround sound 3.0 may include a front left channel, a front right channel, and a rear center channel. Surround sound 9.0 may include a front left channel, a front right channel, a front center channel, a rear left channel, a rear right channel, a side left channel, a side right channel, a left height channel, and a right height channel. Surround sound facility 332 may determine which channel to be presented at which speaker light or device based on the respective locations of the speaker lights and devices. Surround sound facility 322 may cause a speaker light or device to present an audio channel configured to be presented at an audio channel location, wherein the location of the speaker light or device is associated with the audio channel location. For example, a first speaker light may be located at or near the front right of a user, a second speaker light may be located at or near the front left, and a third speaker light may be located at or near the rear center. Then, a front right channel may be presented at the first speaker light, a front left channel may be presented at the second speaker light, and a rear center channel may be presented at the third speaker light. Surround sound facility 332 may also mix or generate audio channels based on the number of speaker lights or devices to be used to present the surround sound media content. The number of speaker lights or devices to be used may be a function of the number of speaker lights or devices within a threshold distance of a wearable device or a user. For example, a media content may be configured to use surround sound 9.0, having nine audio channels. However, only three speaker lights may be detected to be within the same zone as a user. Surround sound facility 332 may use the nine audio channels to generate three audio channels, and present the three audio channels using the three speaker lights.

In some examples, sound direction facility 333 may generate one or more audio control signals to direct one or more audio signals. Directing sound may refer to presenting an audio signal such that a strength, amplitude, or intensity of an audio signal received at the directed location is stronger than that received at other nearby locations. In some examples, a speaker or speaker array of a speaker light or other device may have directionality. The speaker or speaker array may mechanically or electronically direct an audio signal in a certain direction or towards a certain location. In some examples, a plurality of speaker lights or devices may work together to direct sound. Directional sound may be produced based on constructive and deconstructive interferences caused by the audio signals produced by a plurality of speaker lights or devices. Various gains and phases may be applied to the audio signals to be presented at various speaker lights and devices to adjust or adapt the directed sound. Various gains and phases may be adapted by placing a sensor or microphone at the location at which sound is to be directed. Based on the strength of the audio signal received at the microphone, various gains and phases applied to the audio signals presented at the various sources may be adapted. In some examples, another microphone may be placed at another location at which sound is not desired. Based on the audio signals received at the two microphones, various gains and phases may be adapted such that one microphone receives a strong audio signal while the other microphone receives a weak or substantially zero audio signal. In such cases, sound may be presented such that one user may hear the audio signal while another user does not.

In some examples, sound alarm facility 332 may present an audio signal based on certain physiological and/or environmental states detected by one or more sensors. The one or more sensors may be local or remote from the device to be used for presenting the alarm signal, and may be in data communication with an intelligent connection manager. In some examples, one or more templates indicating certain physiological and/or environmental states may be stored in a memory. For example, one template may be a carbon dioxide level exceeding a threshold. Another template may be a baby awakening from sleep, which may include threshold levels associated with the baby's heart rate, galvanic skin response, and the like. Sound alarm facility 332 may receive sensor data, or data representing physiological and/or environmental states, which may be received from a physiological/environmental state facility. Such data may be compared to one or more templates to determine a match within a certain tolerance. Each template may define or specify an audio parameter, and a protocol or method for identifying which speaker light or device to use to present the audio signal using the audio parameter. A template may directly identify the speaker light or device to be used. For example, if a person stands at the front door, present a doorbell sound at the speaker light located in the living room. A template may identify the speaker light or device to be used as a function of its distance from a wearable device or user. For example, a speaker light closest to a wearable device of a certain user may be used to present the audio signal. Still, other functions may be performed by audio control generator 330.

FIG. 3B illustrates an application architecture for a light control generator, according to some examples. As shown, light control generator 340 includes a light direction facility 342 and a light alarm facility 343. Light direction facility 342 may direct one or more lights or radiations in a certain direction or towards a certain location. Directing light may refer to presenting a light such that a strength, amplitude, or intensity of the light received at the directed location is stronger than that received at other nearby locations. In some examples, a light source or light source array of a speaker light or other device may have directionality. The light source or light source array may mechanically or electronically direct a light in a certain direction or towards a certain location. In some examples, a plurality of speaker lights or devices may work together to direct light. For example, two first speaker lights may direct light from different angles substantially towards a wearable device.

Light alarm facility 343 may function similar to sound alarm facility 332, and may present a light based on certain physiological and/or environmental states detected by one or more sensors. In some examples, one or more templates indicating certain physiological and/or environmental states may be stored in a memory. Light alarm facility 343 may receive sensor data, or data representing physiological and/or environmental states, and compare such data to one or more templates. If there is a match within a tolerance, then light alarm facility 343 may trigger an alarm. Each template may define or specify a light parameter, and a protocol or method for identifying which speaker light or device to use to present the light using the light parameter. Still, other functions may be performed by light control generator 340.

FIG. 4 illustrates a speaker light to be used with an intelligent connection manager, according to some examples. Here, device 400 includes housing 402, parabolic reflector 404, positioning mechanism 406, light socket connector 408, passive radiators 410-412, light source 414, circuit board (PCB) 416, speaker 418, frontplate 420, backplate 422 and optical diffuser 424. In some examples, device 400 may be implemented as a combination speaker and light source, which may also be referred to as a “speaker light,” including a controllable light source (i.e., light source 414) and a speaker system (i.e., speaker 418). In some examples, light source 414 may be configured to provide adjustable and controllable light, including an on or off state, varying colors, brightness, and irradiance patterns, without limitation. In some examples, light source 414 may be controlled using a control interface (not shown) in data communication with light source 414 (i.e., using a communication facility implemented on PCB 416) using a wired or wireless network (e.g., power line standards (e.g., G.hn, HomePlugAV, HomePlugAV2, IEEE1901, or the like), Ethernet, WiFi (e.g., 802.11 a/b/g/n/ac, or the like), Bluetooth®, or the like). In some examples, light source 414 may be implemented using one or more light emitting diodes (LEDs) coupled to PCB 416. In other examples, light source 414 may be implemented using a different type of light source (e.g., incandescent, light emitting electrochemical cells, halogen, compact fluorescent, or the like). In some examples, PCB 416 may be bonded to backplate 422, which may be coupled to a driver (not shown) for speaker 418, to provide a heatsink for light source 414. In some examples, light source 414 may direct light towards parabolic reflector 404, as shown. In some examples, parabolic reflector 404 may be configured to direct light from light source 414 towards a front of housing 402 (i.e., towards frontplate 420 and optical diffuser 424), which may be transparent. In some examples, parabolic reflector 404 may be movable (e.g., turned, shifted, or the like) using positioning mechanism 406, either manually or electronically, for example, using a remote control in data communication with circuitry implemented in positioning mechanism 406. For example, parabolic reflector 404 may be moved to change an output light irradiation pattern. In some examples, parabolic reflector 404 may be acoustically transparent such that additional volume within housing 402 (i.e., around and outside of parabolic reflector 404) may be available for acoustic use with a passive radiation system (e.g., including passive radiators 410-412, and the like).

In some examples, light socket connector 408 may be configured to be coupled with a light socket (e.g., standard Edison screw base, as shown, bayonet mount, bi-post, bi-pin, or the like) for powering (i.e., electrically) device 400. In some examples, light socket connector 408 may be coupled to housing 402 on a side opposite to optical diffuser 424 and/or speaker 418. In some examples, housing 402 may be configured to house one or more of parabolic reflector 404, positioning mechanism 406, passive radiators 410-412, light source 414, PCB 416, speaker 418 and frontplate 420. Electronics (not shown) configured to support control, audio playback, light output, and other aspects of device 400, may be mounted anywhere inside or outside of housing 402. In some examples, light socket connector 408 may be configured to receive power from a standard light bulb or power connector socket (e.g., E26 or E27 screw style, TI2 or GU4 pins style, or the like), using either or both AC and DC power. In some examples, device 400 also may be implemented with an Ethernet connection.

In some examples, speaker 418 may be suspended in the center of frontplate 420, which may be sealed. In some examples, frontplate 420 may be transparent and mounted or otherwise coupled with one or more passive radiators. In some examples, speaker 418 may be configured to be controlled (e.g., to play audio, to tune volume, or the like) remotely using a controller (not shown) in data communication with speaker 418, using a wired or wireless network. In some examples, housing 402 may be acoustically sealed to provide a resonant cavity when combined with passive radiators 410-412 (or other passive radiators, for example, disposed on frontplate 420 (not shown). In other examples, radiators 410-412 may be disposed on a different internal surface of housing 402 than shown. The combination of an acoustically sealed housing 402 with one or more passive radiators (e.g., passive radiators 410-412) improves low frequency audio signal reproduction, while optical diffuser 422 is acoustically transparent, thus sound from speaker 418 may be projected out of housing 402 through optical diffuser 424. In some examples, optical diffuser 424 may be configured to be waterproof (e.g., using a seal, chemical waterproofing material, and the like). In some examples, optical diffuser 424 may be configured to spread light (i.e., reflected using parabolic reflector 404) evenly as light exits housing 402 through a transparent frontplate 420. In some examples, optical diffuser 424 may be configured to be acoustically transparent in a frequency selective manner, functioning as an additional acoustic chamber volume (i.e., as part of a passive radiator system including housing 402, radiators 410-412, and other components of device 400).

In some examples, sensors (not shown) may be installed or located on speaker light 400. Speaker light 400 may be configured to be installed on a ceiling or an upper location of a room or environment. Sensors located at speaker light 400 may have a birds' eye view of the vicinity. Sensors may capture sensor data with minimal or no horizontal obstruction or interference. In some examples, multiple speaker lights 400 may be installed, and may be distributed within an environment. In such cases, multiple sensors may be distributed in the environment. In other examples, the quantity, type, function, structure, and configuration of the elements shown may be varied and are not limited to the examples provided.

FIG. 5 illustrates an application architecture of a speaker light, according to some examples. Here, speaker light 504 includes bus 501, sensor 511, communications facility 512, audio controller 513, and light controller 514. Sensor 511 may be one or more sensors, and may be used to capture or detect a variety of characteristics. Sensor 511 may generate sensor data to be used by an intelligent connection manager. In some examples, sensor 511 may include an altimeter/barometer, light/infrared (“IR”) sensor, audio sensor (e.g., microphone, transducer, or others), GPS receiver or other location sensor, thermometer, environmental sensor, signal strength sensor, ultrasonic sensor, voice recognition sensor, or others. An altimeter/barometer may be used to measure environmental pressure, atmospheric or otherwise, and is not limited to any specification or type of pressure-reading device. An IR sensor may be used to measure light or photonic conditions. An audio sensor may be used to record or capture sound. A GPS receiver may be used to obtain coordinates of a geographic location using, for example, various types of signals transmitted by civilian and/or military satellite constellations in low, medium, or high earth orbit (e.g., “LEO,” “MEO,” or “GEO”). In some examples, differential GPS algorithms may also be implemented with a GPS receiver, which may be used to generate more precise or accurate coordinates. In other examples, a location sensor may be used to determine a location within a cellular or micro-cellular network, which may or may not use GPS or other satellite constellations. A thermometer may be used to measure user or ambient temperature. An environmental sensor may be used to measure environmental conditions, including ambient light, sound, temperature, chemicals, etc. A signal strength sensor may be used to detect a strength of a wireless signal (e.g., Wi-Fi, Bluetooth, 3G, 4G, etc.) transmitted from a transmitter, which may be used to determine a distance of the transmitter. An ultrasonic sensor may be used to determine a distance and/or location of an object or person. A voice recognition sensor may be used to detect speech in an audio signal, and to determine a person providing the speech using characteristics of the speech (e.g., frequency, amplitude, etc.). Still, other types and combinations of sensors may be used.

Communications facility 512 may be used to establish wired or wireless communication with other devices. In some examples, speaker light 504 may be remote from an intelligent connection manager. Communications facility 512 may be used to transmit sensor data from speaker light 504 to an intelligent connection manager, and may be used to receive control signals from the intelligent connection manager. In other examples, speaker light 504 may be integrated with an intelligent connection manager. Data and control signals may be communicated using bus 501.

Audio controller 513 may be configured to present an audio signal at speaker light 504 using one or more audio parameters. An audio parameter may be included in an audio control signal received from an intelligent connection manager using communications facility 512. For example, audio controller 513 may control the audio content, volume, direction, and the like, of an audio signal. Light controller 514 may be configured to present a light or radiation at speaker light 504 using one or more light parameters. A light parameter may be included in a light control signal received from an intelligent connection manager using communications facility 512. For example, light controller 514 may control the color, brightness, direction, and the like, of a light. Still, other implementations of a speaker light may be possible.

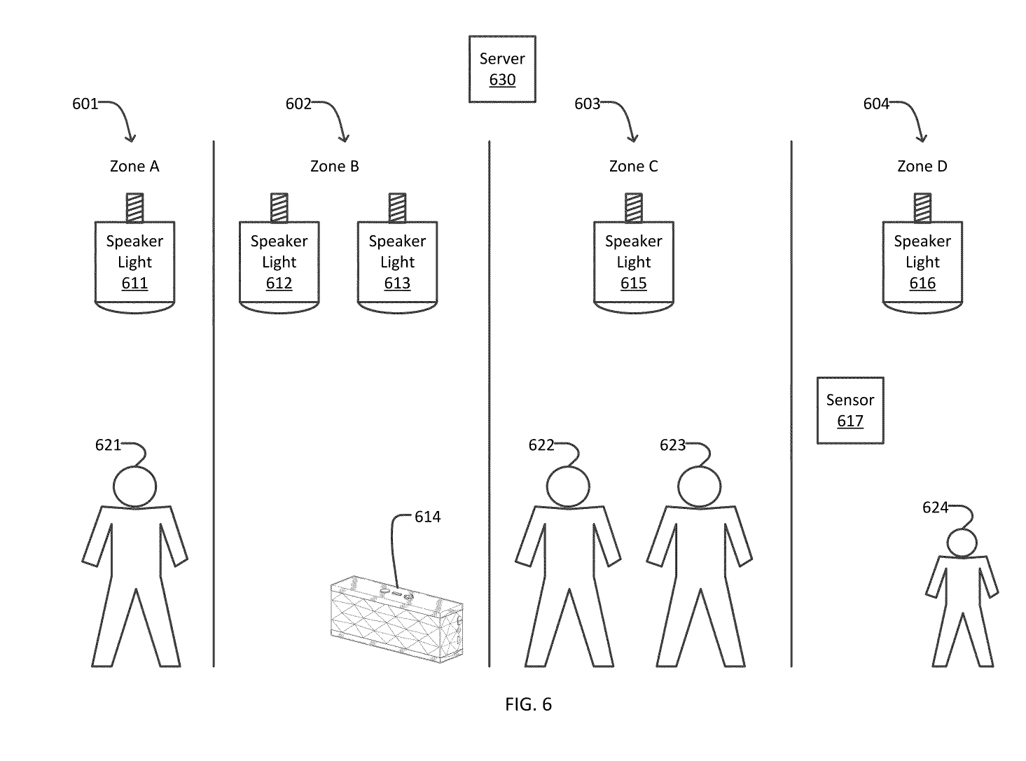

FIG. 6 illustrates a network of speaker lights, wearable devices, and other devices, using an intelligent connection manager, according to some examples. As shown, FIG. 6 includes Zones A-D 601-604, users 621-624, devices 611-617, and server 630. In some examples, an intelligent connection manager may be implemented at server 630, which may be in data communication with devices 611-617 as well as wearable devices of users 621-624. For example, a sensor coupled to speaker light 611 may detect a signal strength transmitted from a wearable device of user 621, and transmit data representing the signal strength to the intelligent connection manager. Intelligent connection manager may determine user 621 is within Zone A 601, and may generate control signals to present an audio signal and a light at speaker light 611. For example, user 621 may then leave Zone A 601 and enter Zone B 602. A sensor coupled to speaker light 612 may detect a signal strength transmitted from a wearable device of user 621, and intelligent connection manager may determine that user 621 is within Zone B 602. Intelligent connection manager may further determine that speaker light 613 and media device 614 are associated with the same grouping as speaker light 612. Intelligent connection manager may determine that devices 612-614 may be used to present a surround sound to user 621. Intelligent connection manager may determine a location of devices 612-614 with respect to user 621, and may present audio channels at devices 612-614, each audio signal configured to be presented at an audio channel location that is associated with or correlated with the location of devices 612-614. Intelligent connection manager may further determine that user 621 has left Zone A 601 and turn off speaker light 611.

For example, users 622 and 623 may be located in Zone C 603. Speaker light 615 may detect wireless signals from wearable devices of users 622 and 623, and the intelligent connection manager may determine that there are two users in Zone C 603. Intelligent connection manager may present a dim light and soft music at speaker light 615. User 621 may enter Zone C 603, which may be detected by the intelligent connection manager. Intelligent connection manager may determine whether to continue playing the soft music at speaker light 615, or to present the audio that user 621 was listening to while in Zone B 602. Intelligent connection manager may determine whether to adjust an audio parameter and/or light parameter based on user settings, based on the number of people in the zone, based on the activity in which the users are engaged, and the like. For example, user 621 may enter Zone C 603 to join the social setting of users 622 and 623. Intelligent connection manager may determine that audio parameters and light parameters may remain the same, and speaker light 615 may continue to present a dim light and soft music.

For example, user 624, who may be a child, may be located in Zone D 604. User 624 may be sleeping in Zone D 604. An external sensor 617 may be used to detect environmental states, such as a level of carbon dioxide. Data representing a level of carbon monoxide may be transmitted from sensor 617 to an intelligent connection manager implemented at server 630. Intelligent connection manager may determine that the level of carbon monoxide exceeds a threshold. Intelligent connection manager may generate a control signal to present a light at speaker light 616, which may be used to wake up user 624. Intelligent connection manager may also generate a control signal to present an audio alarm at a device closest to user 621. Intelligent connection manager may determine that speaker light 615 is the closest device to 621. Intelligent connection manager may pause or stop presenting the soft music, and present an alarm (e.g., a beep, a voice message stating that the carbon dioxide at Zone D exceeds a threshold, etc.) at speaker light 615. Still, other implementations and uses may be possible.

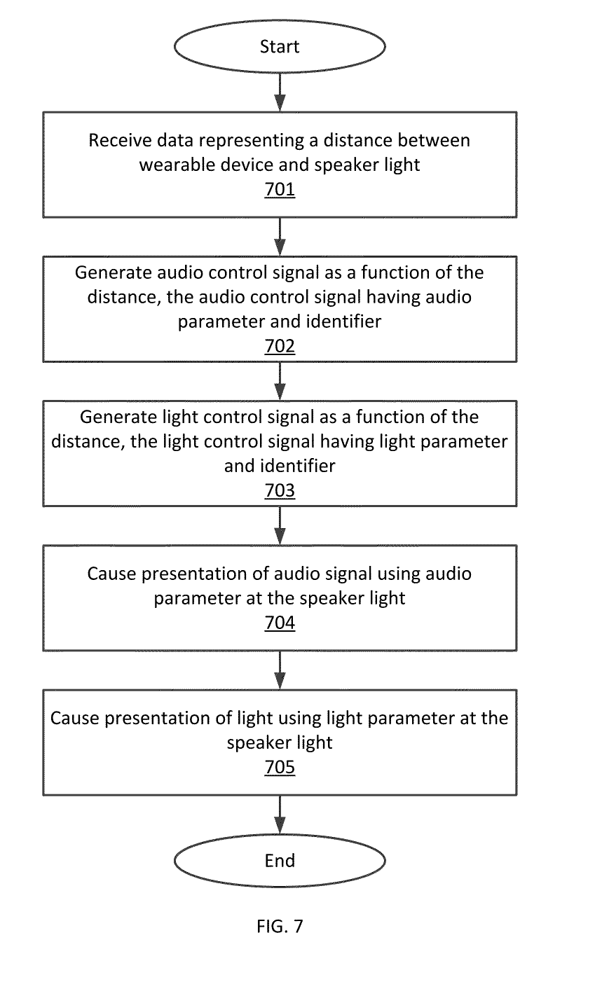

FIG. 7 illustrates a process for an intelligent connection manager, according to some examples. At 701, data representing a distance between a wearable device and a speaker light may be received. The distance may be determined locally at the intelligent connection manager or remotely. The speaker light may have an identifier, such as an address, name, unique identity number, and the like. At 702, an audio control signal may be generated as a function of the distance. The audio control signal may include an audio parameter and the identifier of the speaker light. The audio parameter may specify a characteristic of the audio signal to be presented at the speaker light. At 703, a light control signal may be generated as a function of the distance. The light control signal may include a light parameter and the identifier of the speaker light. The light parameter may specify a characteristic of the light or radiation to be presented at the speaker light. At 704, presentation of an audio signal using the audio parameter is caused at the speaker light. At 705, presentation of a light using the light parameter is caused at the speaker light.

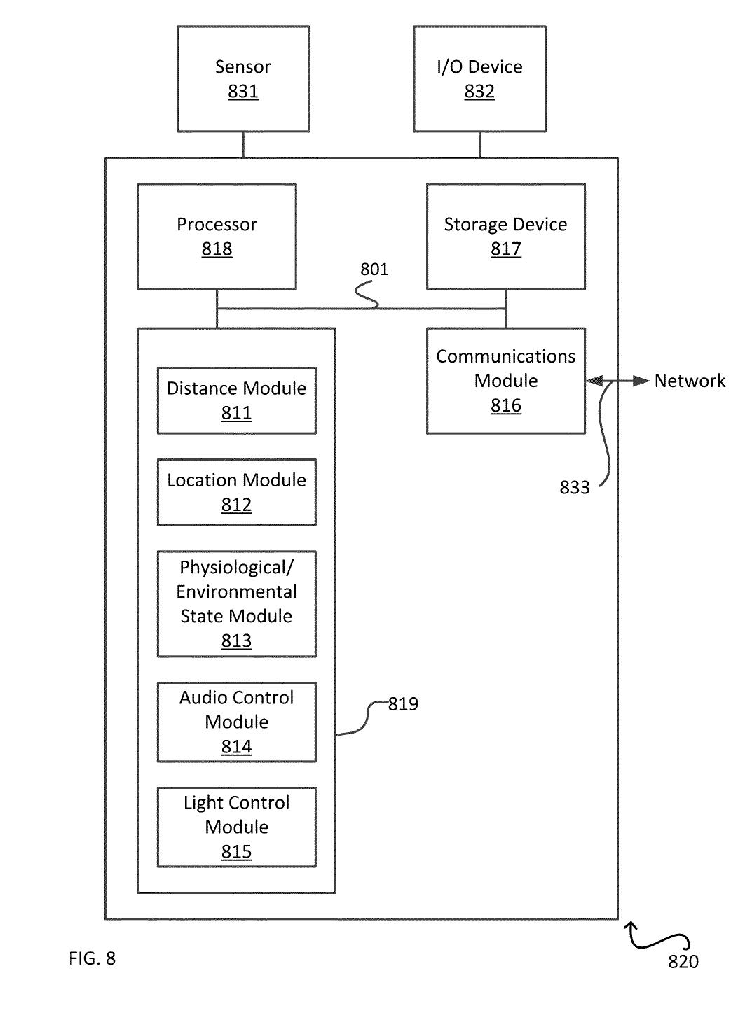

FIG. 8 illustrates a computer system suitable for use with an intelligent connection manager, according to some examples. In some examples, computing platform 820 may be used to implement computer programs, applications, methods, processes, algorithms, or other software to perform the above-described techniques. Computing platform 820 includes a bus 801 or other communication mechanism for communicating information, which interconnects subsystems and devices, such as processor 818, system memory 819 (e.g., RAM, etc.), storage device 817 (e.g., ROM, etc.), a communications module 816 (e.g., an Ethernet or wireless controller, a Bluetooth controller, etc.) to facilitate communications via a port on communication link 833 to communicate, for example, with a computing device, including mobile computing and/or communication devices with processors. Processor 818 can be implemented with one or more central processing units (“CPUs”), such as those manufactured by Intel® Corporation, or one or more virtual processors, as well as any combination of CPUs and virtual processors. Computing platform 820 exchanges data representing inputs and outputs via input-and-output devices 832, including, but not limited to, keyboards, mice, audio inputs (e.g., speech-to-text devices), user interfaces, displays, monitors, cursors, touch-sensitive displays, LCD or LED displays, and other I/O-related devices. An interface is not limited to a touch-sensitive screen and can be any graphic user interface, any auditory interface, any haptic interface, any combination thereof, and the like. Computing platform 820 may also receive sensor data from sensor 831, including a signal strength detector, an environmental sensor, a GPS receiver, and the like.

According to some examples, computing platform 820 performs specific operations by processor 818 executing one or more sequences of one or more instructions stored in system memory 819, and computing platform 820 can be implemented in a client-server arrangement, peer-to-peer arrangement, or as any mobile computing device, including smart phones and the like. Such instructions or data may be read into system memory 819 from another computer readable medium, such as storage device 817. In some examples, hard-wired circuitry may be used in place of or in combination with software instructions for implementation. Instructions may be embedded in software or firmware. The term “computer readable medium” refers to any tangible medium that participates in providing instructions to processor 818 for execution. Such a medium may take many forms, including but not limited to, non-volatile media and volatile media. Non-volatile media includes, for example, optical or magnetic disks and the like. Volatile media includes dynamic memory, such as system memory 819.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 801 for transmitting a computer data signal.

In some examples, execution of the sequences of instructions may be performed by computing platform 820. According to some examples, computing platform 820 can be coupled by communication link 833 (e.g., a wired network, such as LAN, PSTN, or any wireless network) to any other processor to perform the sequence of instructions in coordination with (or asynchronous to) one another. Computing platform 820 may transmit and receive messages, data, and instructions, including program code (e.g., application code) through communication link 833 and communication interface 816. Received program code may be executed by processor 818 as it is received, and/or stored in memory 819 or other non-volatile storage for later execution.

In the example shown, system memory 819 can include various modules that include executable instructions to implement functionalities described herein. In the example shown, system memory 819 includes distance module 811, location module 812, physiological/environmental state module 813, audio control module 815, and light control module 815.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed:

1. A method, comprising:
receiving data representing a first distance between a first wearable device and a first speaker light, the first speaker light associated with a first identifier;
generating a first audio control signal as a function of the first distance, the first audio control signal comprising data representing a first audio parameter and data representing the first identifier;
generating a first light control signal as a function of the first distance, the first light control signal comprising data representing a first light parameter and data representing the first identifier;
causing presentation of a first audio signal using the first audio parameter at the first speaker light; and
causing presentation of a first light using the first light parameter at the first speaker light.

2. The method of claim 1, further comprising:
receiving data representing a second distance between the first wearable device and a second speaker light, the second speaker light associated with a second identifier;
determining a first location of the first speaker light with respect to the first wearable device using the first distance and the second distance;
determining a second location of the second speaker light with respect to the first wearable device using the first distance and the second distance;
generating the first audio control signal and the first light control signal as a function of the first location;
generating a second audio control signal as a function of the second location, the second audio control signal comprising data representing a second audio parameter and data representing the second identifier;
generating a second light control signal as a function of the second location, the second light control signal comprising data representing a second light parameter and data representing the second identifier;
causing presentation of a second audio signal using the second audio parameter at the second speaker light; and
causing presentation of a second light using the second light parameter at the second speaker light.

3. The method of claim 2, further comprising:
generating the first audio parameter to present a first audio channel, the first audio channel configured to be presented at a source located at a first audio channel location, the first audio channel location being associated with the first location; and
generating the second audio parameter to present a second audio channel, the second audio channel configured to be presented at another source located at a second audio channel location, the second audio channel location being associated with the second location.

4. The method of claim 2, further comprising:
receiving a first audio data from a first audio sensor coupled to the first wearable device;
receiving a second audio data from a second audio sensor coupled to a second wearable device;
adapting the first audio signal and the second audio signal such that an amplitude associated with the first audio data is greater than an amplitude associated with the second audio data.

5. The method of claim 4, wherein the adapting the first audio signal and the second audio signal comprises:
adapting a first gain and a first phase applied to the first audio signal and adapting a second gain and a second phase applied to the second audio signal.

6. The method of claim 1, further comprising:
determining a first location of the first speaker light with respect to the first wearable device; and
generating the first audio parameter to direct the first audio signal substantially towards the first wearable device, such that an amplitude of the first audio signal received at the first wearable device is greater than the amplitude of the first audio signal received at another location, the first wearable device and the another location being substantially a same distance away from the first speaker light.

7. The method of claim 1, further comprising;
receiving data representing a second distance between a first wearable device and a second speaker light;
determining the first distance is within a first threshold;
determining the second distance exceeds a second threshold;
causing no audio signal and no light to be presented at the second speaker light.

8. The method of claim 1, further comprising:
receiving data representing a second distance between a second wearable device and the first speaker light;
modifying the first audio parameter as a function of the first distance and the second distance; and
modifying the first light parameter as a function of the first distance and the second distance

9. The method of claim 1, further comprising:
receiving sensor data from a sensor coupled to a second speaker light; and
determining a match between the sensor data and a sensor data template, the sensor data template being associated with the first audio parameter and the first light parameter and being stored in a memory.

10. The method of claim 1, further comprising:
determining a grouping including the first speaker light and a second speaker light, the second speaker light associated with a second identifier;
generating a second audio control signal as a function of the grouping, the second audio control signal comprising data representing a second audio parameter and data representing the second identifier;
generating a second light control signal as a function of the grouping, the second light control signal comprising data representing a second light parameter and data representing the second identifier;
causing presentation of a second audio signal using the second audio parameter at the second speaker light; and
causing presentation of a second light using the second light parameter at the second speaker light.

11. A system, comprising:
a distance facility configured to cause storage of data representing a first distance between a first wearable device and a first speaker light at a memory, the first speaker light associated with a first identifier;
an audio control generator configured to generate a first audio control signal as a function of the first distance, the first audio control signal comprising data representing a first audio parameter and data representing the first identifier;
a light control generator configured to generate a first light control signal as a function of the first distance, the first light control signal comprising data representing a first light parameter and data representing the first identifier; and
a communications facility configured to cause transmission of the first audio control signal to the first speaker light to cause presentation of a first audio signal using the first audio parameter at the first speaker light, and to cause transmission of the first light control signal to the first speaker light to cause presentation of a first light using the first light parameter at the first speaker light.

12. The system of claim 11, further comprising:
a location facility configured to determine a first location of the first speaker light with respect to the first wearable device using the first distance and a second distance between the first wearable device and a second speaker light, and to determine a second location of the second speaker light with respect to the first wearable device using the first distance and the second distance;
wherein the second speaker light is associated with a second identifier;
the audio control generator is further configured to generate a second audio control signal as a function of the second location, the second audio control signal comprising data representing a second audio parameter and data representing the second identifier; and
the light control generator is further configured to generate a second light control signal as a function of the second location, the second light control signal comprising data representing a second light parameter and data representing the second identifier.

13. The system of claim 12, wherein:
the audio control generator is further configured to generate the first audio parameter to present a first audio channel, the first audio channel configured to be presented at a source located at a first audio channel location, the first audio channel location being associated with the first location, and to generate the second audio parameter to present a second audio channel, the second audio channel configured to be presented at another source located at a second audio channel location, the second audio channel location being associated with the second location.

14. The system of claim 12, wherein:
the communications facility is further configured to receive a first audio data from a first audio sensor coupled to the first wearable device, and to receive a second audio data from a second audio sensor coupled to a second wearable device; and
the audio control generator is further configured to adapt the first audio signal and the second audio signal such that an amplitude associated with the first audio data is greater than an amplitude associated with the second audio data.

15. The system of claim 14, wherein the audio control generator is configured to adapt the first audio signal and the second audio signal by adapting a first gain and a first phase applied to the first audio signal and adapting a second gain and a second phase applied to the second audio signal.

16. The system of claim 11, further comprising:
a location facility is configured to determine a first location of the first speaker light with respect to the first wearable device;
wherein the audio control generator is further configured to generate the first audio parameter to direct the first audio signal substantially away from the first wearable device, such that an amplitude of the first audio signal received at the first wearable device is less than the amplitude of the first audio signal received at another location, the first wearable device and the another location being substantially a same distance away from the first speaker light.

17. The system of claim 11, wherein:
the distance facility is further configured to cause storage of data representing a second distance between a first wearable device and a second speaker light at the memory, to determine the first distance is within a first threshold, and to determine the second distance exceeds a second threshold;
the audio control generator is further configured to cause no audio signal to be presented at the second speaker light; and
the light control generator is further configured to cause no light to be presented at the second speaker light.

18. The system of claim 11, wherein:
the distance facility is further configured to cause storage of data representing a second distance between a second wearable device and the first speaker light at the memory;
the audio control generator is configured to modify the first audio parameter as a function of the first distance and the second distance; and
the light control generator is configured to modify the first light parameter as a function of the first distance and the second distance.

19. The system of claim 11, further comprising:
a physiological and environmental state facility configured to determine a match between sensor data received from a sensor coupled to a second speaker light and a sensor data template, the sensor data template being associated with the first audio parameter and the first light parameter and being stored in a memory.

20. The system of claim 11, further comprising:
a grouping facility configured to store a grouping including the first speaker light and a second speaker light, the second speaker light associated with a second identifier;
wherein the audio control generator is further configured to generate a second audio control signal as a function of the grouping; and
the light control generator is further configured to generate a second light control signal as a function of the grouping.
